(19) United States
(12) Patent Application Publication
(10) Pub. No.: US 2026/0087850 A1
(43) Pub. Date: Mar. 26, 2026

(54) SYSTEMS AND METHODS OF PROCESSING BASED ON USER QUERIES AND GAZE

(71) Applicant: Apple Inc., Cupertino, CA (US)

(72) Inventors: William D. LINDMEIER, San Francisco, CA (US); Devin W. CHALMERS, Oakland, CA (US); Sean B. KELLY, San Francisco, CA (US)

(21) Appl. No.: 19/330,484

(22) Filed: Sep. 16, 2025

Related U.S. Application Data
(60) Provisional application No. 63/699,659, filed on Sep. 26, 2024.

(51) Int. Cl. G06V 40/18; G06F 3/01; G06V 10/26; G06V 20/20; G06V 20/68

(52) U.S. Cl. CPC G06V 40/193; G06F 3/013; G06V 10/273; G06V 20/20; G06V 20/68

(57) ABSTRACT

In some examples, an electronic device in communication with one or more input devices detects an input and a gaze direction of a user of the electronic device. In some examples, in response to the input, the electronic device captures one or more images. In some examples, using the detected gaze direction and a portion of the input, the electronic device identifies a subset of at least a first image from the captured images. If certain criteria are satisfied, the electronic device performs an operation using processing circuitry based on processing the input, the captured images, and the identified subset of the first image.

### CROSS REFERENCE TO RELATED APPLICATIONS

This application claims the benefit of U.S. Provisional Application No. 63/699,659, filed Sep. 26, 2024, the entire disclosure of which is herein incorporated by reference for all purposes.

### FIELD OF THE DISCLOSURE

This disclosure relates generally to processing based on user queries and gaze, and more particularly, to performing an action based on processing an image and a subset of the image determined based on the user query and gaze.

### BACKGROUND OF THE DISCLOSURE

Electronic devices, such as mobile phones and laptop computers, can include a digital assistant. The digital assistant of the electronic device can receive a user query in the form of a natural language input, and cause the electronic device to perform an action in response to the user query.

### SUMMARY OF THE DISCLOSURE

An electronic device, such as a head-mounted device, is equipped with or communicates with one or more input devices. In some examples, the input devices include one camera to detect a user's gaze and one or more cameras to detect an environment. In some examples, the input devices also include one or more text or audio input components (e.g., microphones, keyboards, touch sensor panels, etc.). In some examples, the electronic device uses the one or more cameras to capture an image of the environment and uses a user's gaze to capture a subset of the image of the environment (e.g., a cropped version of the image). In effect, the gaze is used to capture a region of interest toward which the gaze is directed. The region of interest can include one or more objects of interest. In some examples, one or more characteristics of the region of interest is based on the user query (e.g., a voice or text input). In some examples, the image, the subset of the image, and the user query are inputs from which an action can be determined. Use of gaze with the user query can improve the accuracy of the operation performed by the electronic device in response to the user input.

The full descriptions of the examples are provided in the Drawings and the Detailed Description, and it is understood that the Summary of the Disclosure provided above does not limit the scope of the disclosure in any way.

### BRIEF DESCRIPTION OF THE DRAWINGS

For a better understanding of the various described examples, reference should be made to the Detailed Description below, in conjunction with the following drawings in which like reference numerals refer to the corresponding parts throughout the Figures.

FIG. 1 illustrates an electronic device presenting a three-dimensional environment and a hand-held electronic device according to some examples of the disclosure.

FIGS. 2A-2B illustrate block diagrams of example architectures for electronic devices according to some examples of the disclosure.

FIG. 3A-3R illustrate various examples of the electronic device presenting the three-dimensional environment while performing an operation based on a combination of a user query, an image of the three-dimensional environment, and a cropped image of the three-dimensional environment according to some examples of this disclosure.

FIG. 4 illustrates a method of performing an operation based on a user query in combination with the image of the three-dimensional environment and cropped image according to some examples of this disclosure.

### DETAILED DESCRIPTION

In the following description of examples, reference is made to the accompanying drawings which form a part hereof, and in which it is shown by way of illustration specific examples that are optionally practiced. It is to be understood that other examples are optionally used, and structural changes are optionally made without departing from the scope of the disclosed examples.

An electronic device, such as a head-mounted device, is equipped with or communicates with one or more input devices. In some examples, the input devices include one cameras to detect a user's gaze and one or more cameras to detect an environment. In some examples, the input devices also include one or more text or audio input components (e.g., microphones, keyboards, touch sensor panels, etc.). In some examples, the electronic device uses the one or more cameras to capture an image of the environment and uses a user's gaze to capture a subset of the image of the environment (e.g., a cropped version of the image). In effect, the gaze is used to capture a region of interest toward which the gaze is directed. The region of interest can include one or more objects of interest. In some examples, one or more characteristics of the region of interest is based on the user query (e.g., a voice or text input). In some examples, the image, the subset of the image, and the user query are inputs from which an action can be determined. Use of gaze with the user query can improve the accuracy of the operation performed by the electronic device in response to the user input.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described examples. The first touch and the second touch are both touches, but they are not the same touch.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

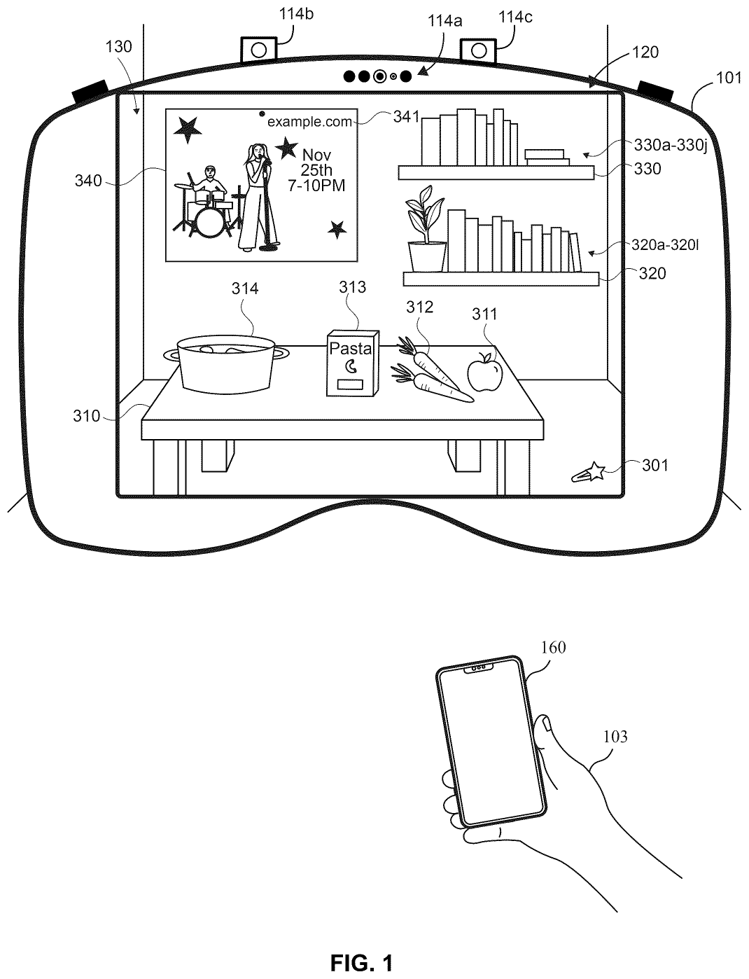

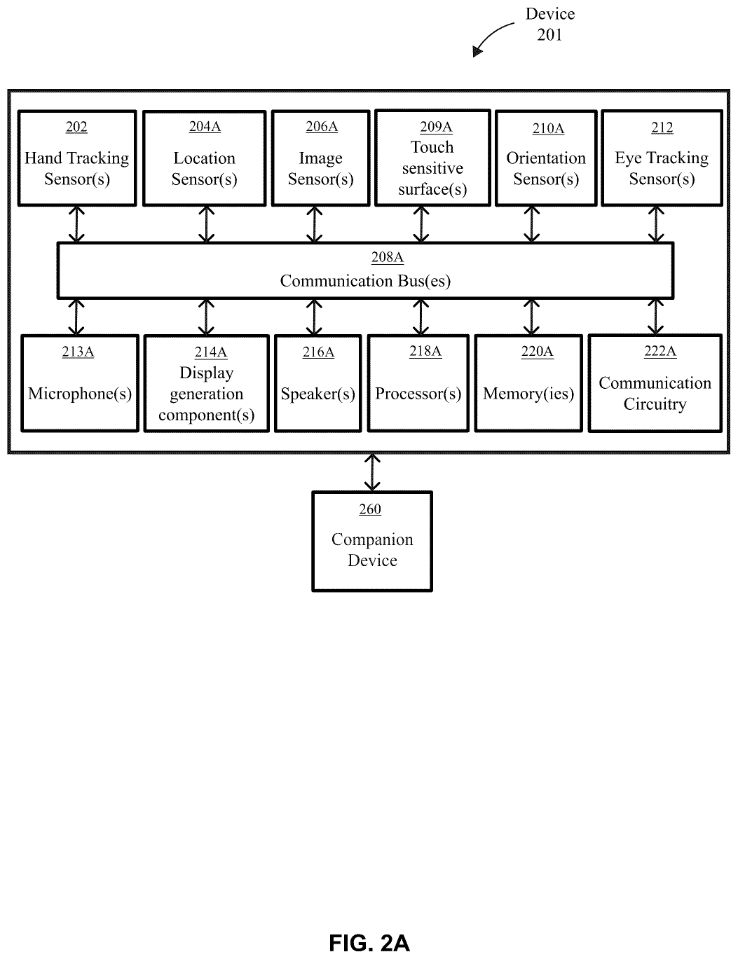

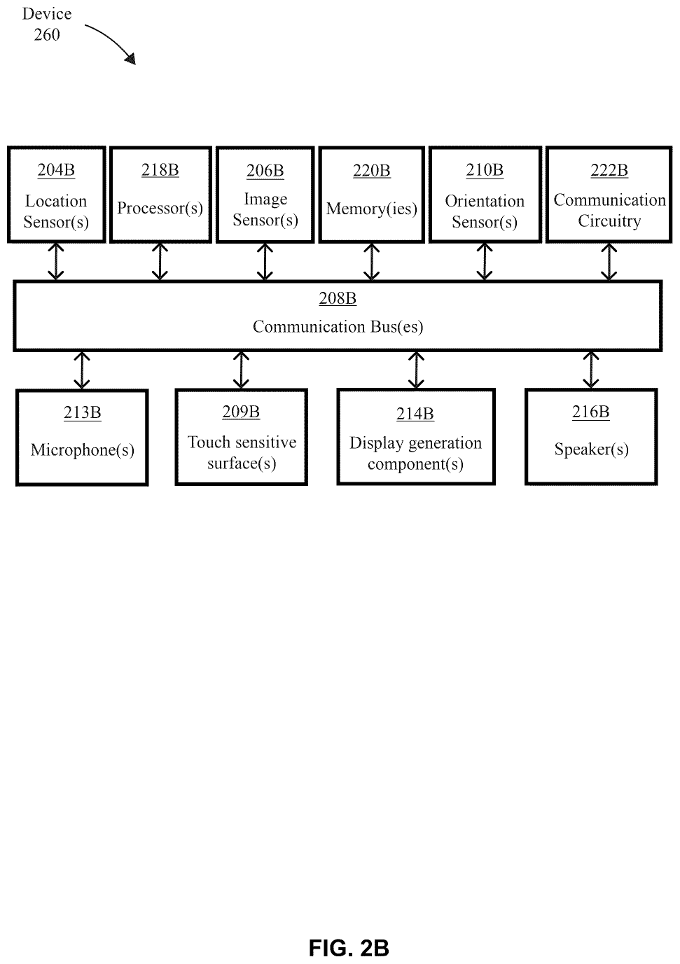

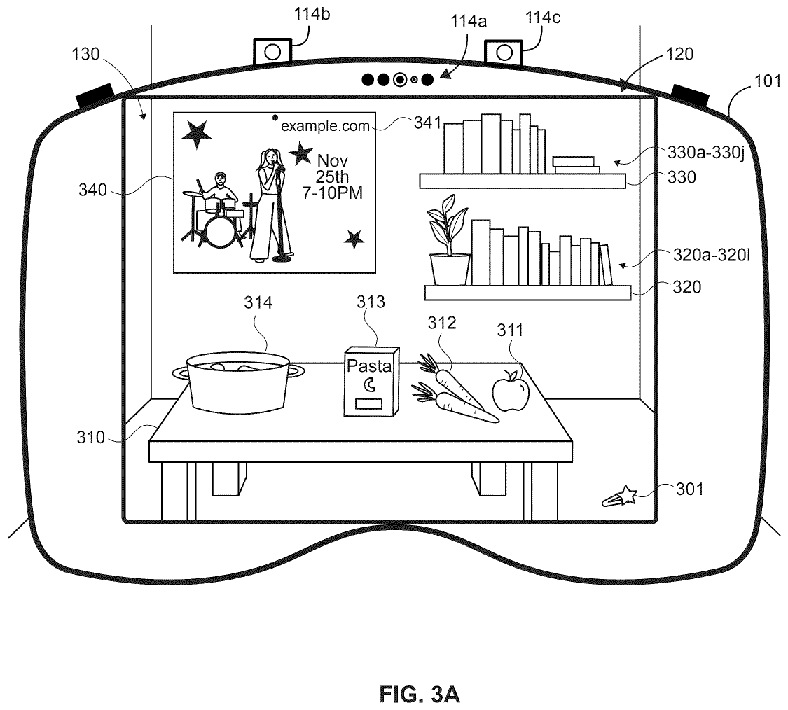

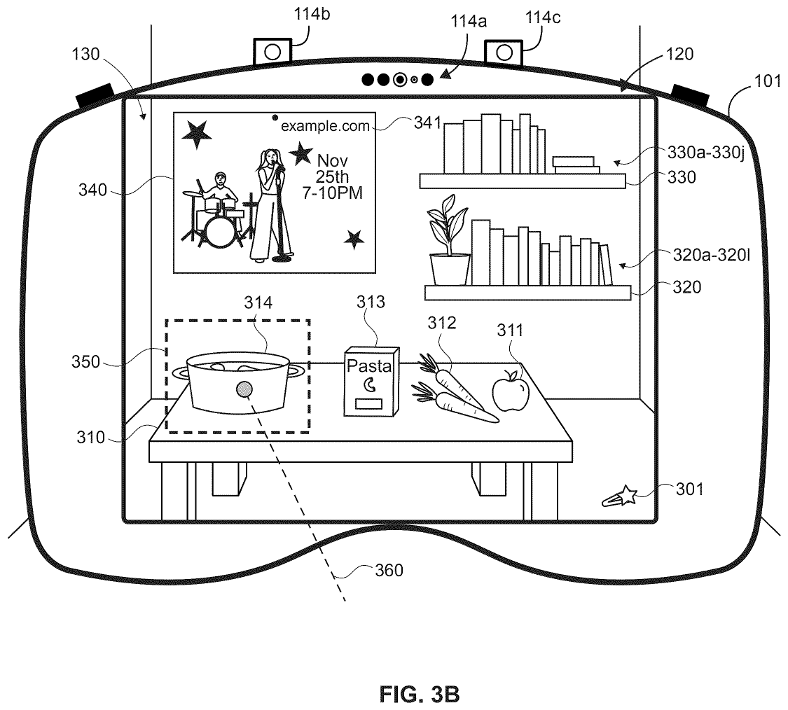

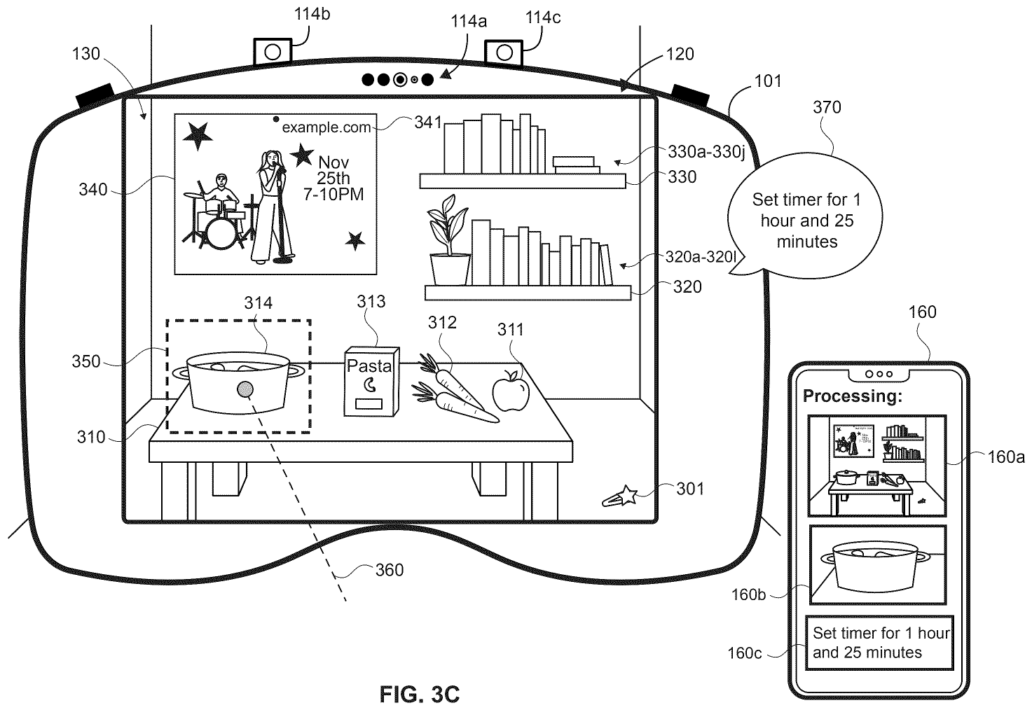

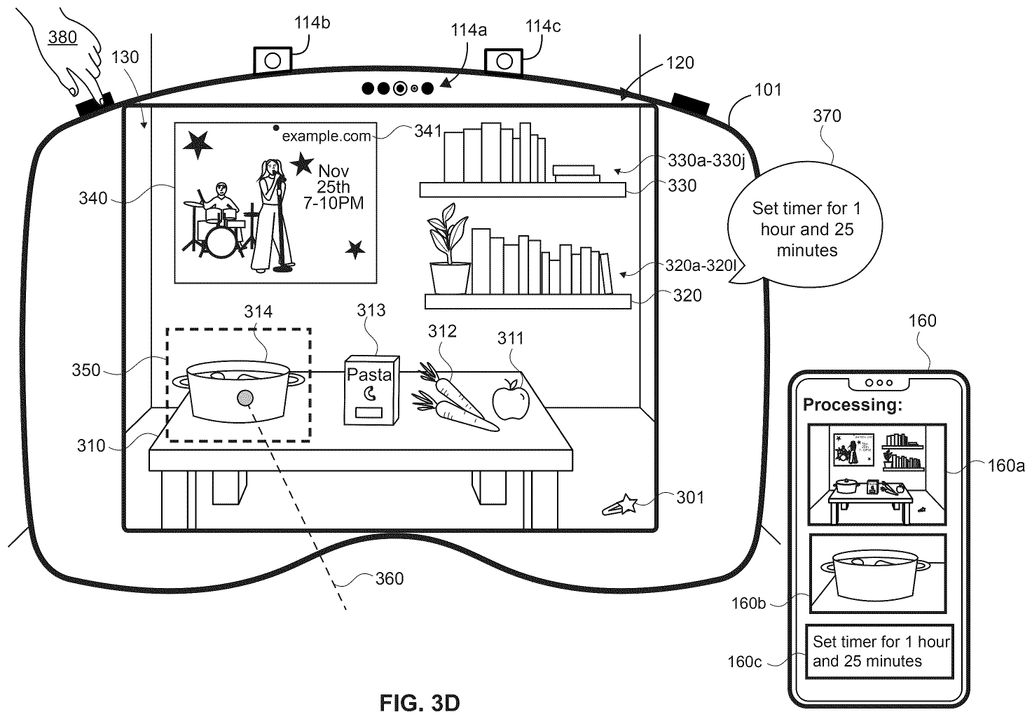

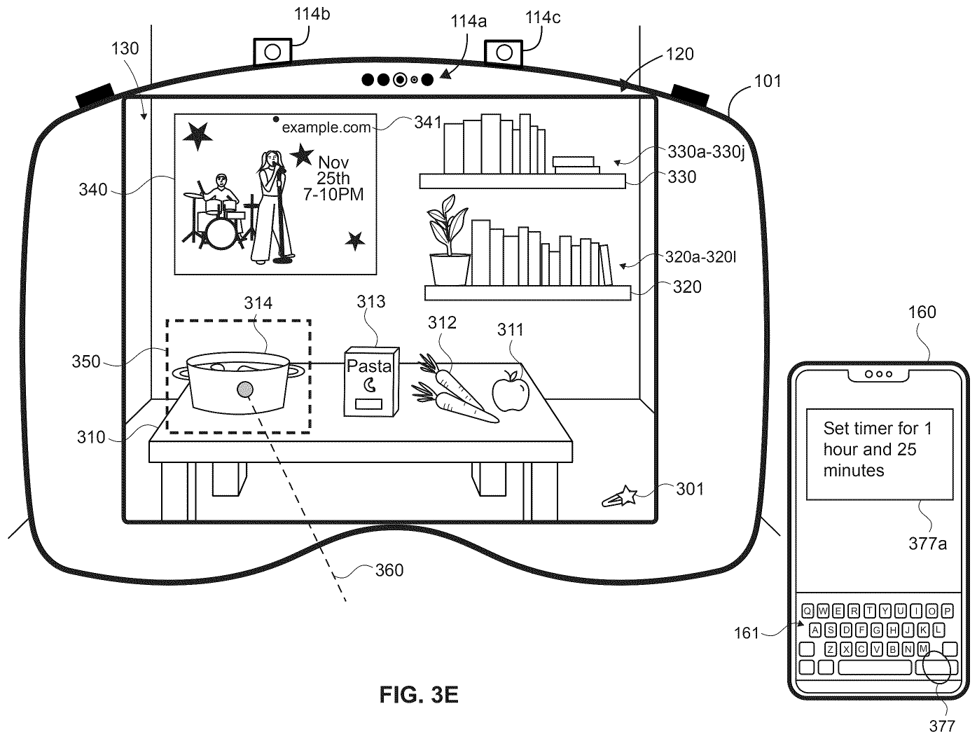

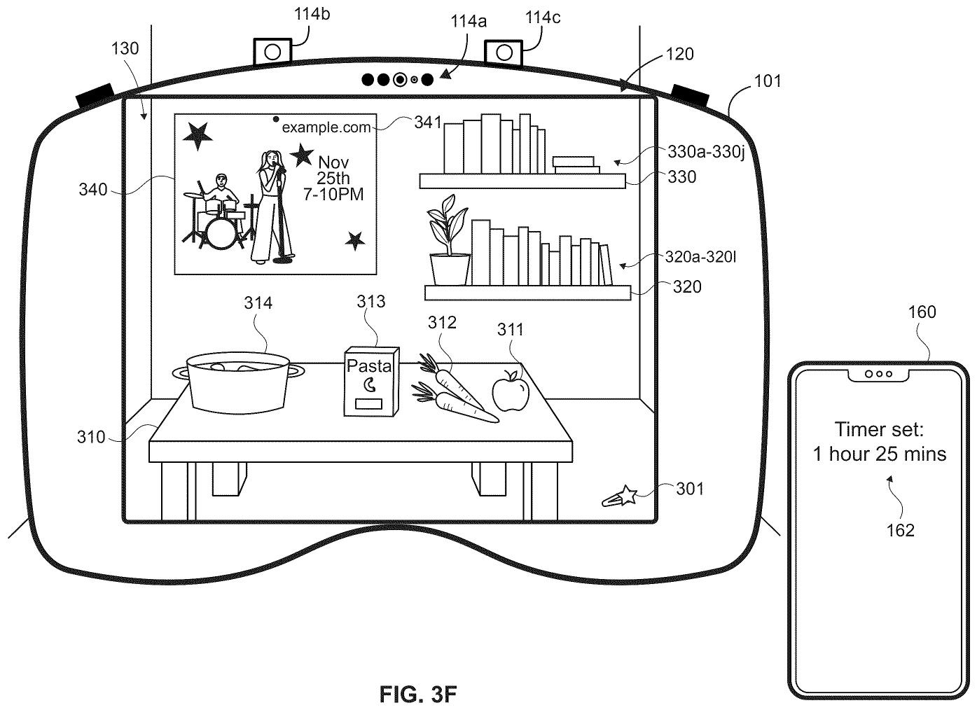

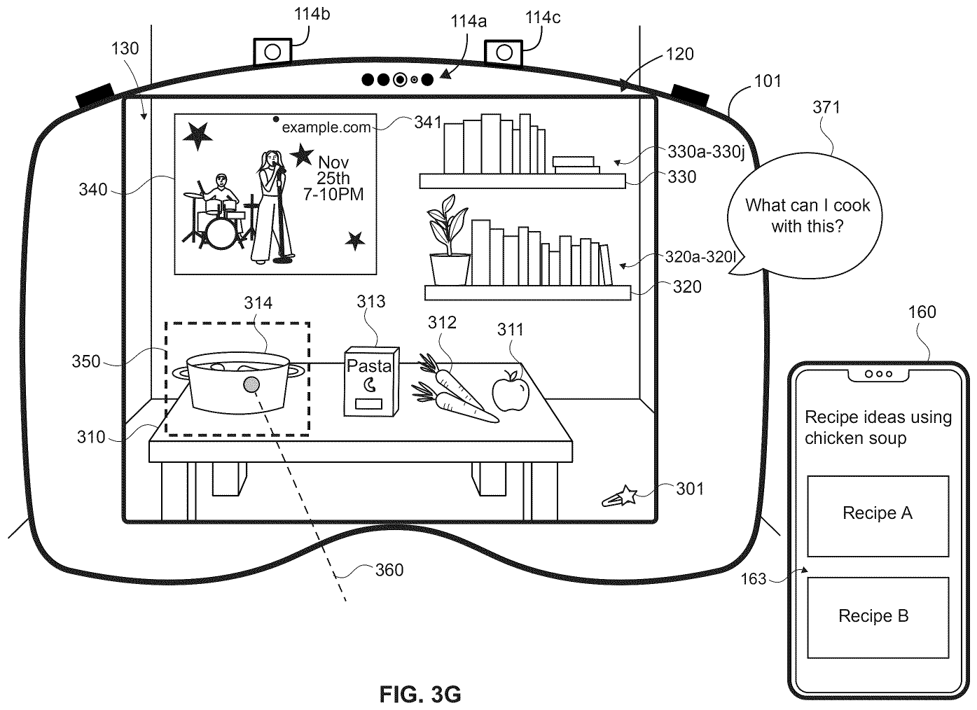

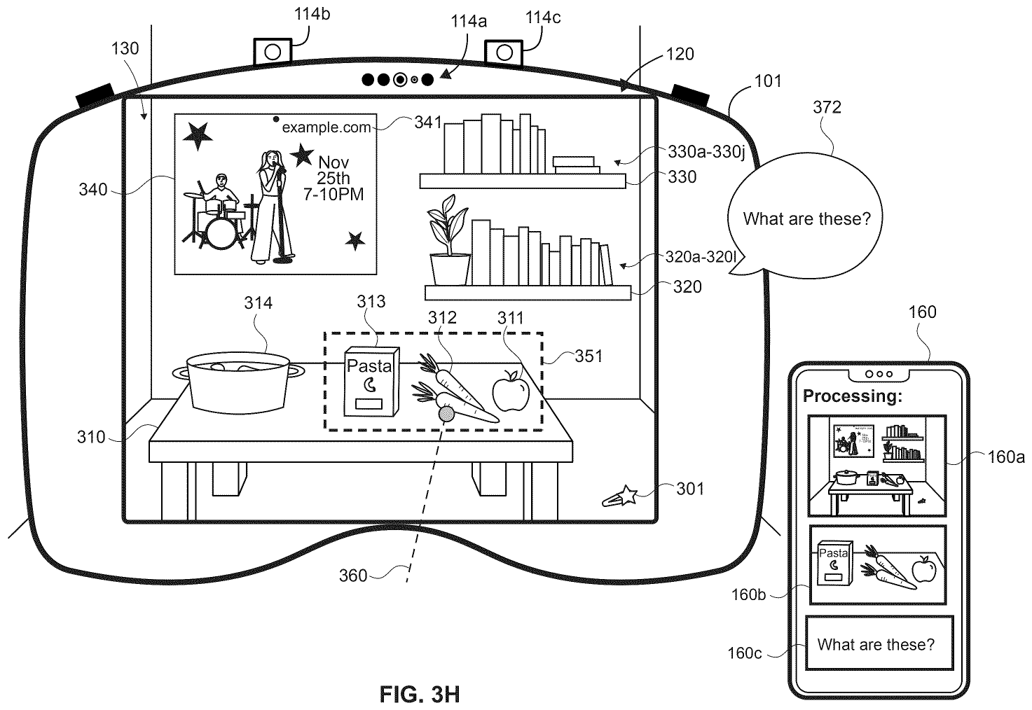

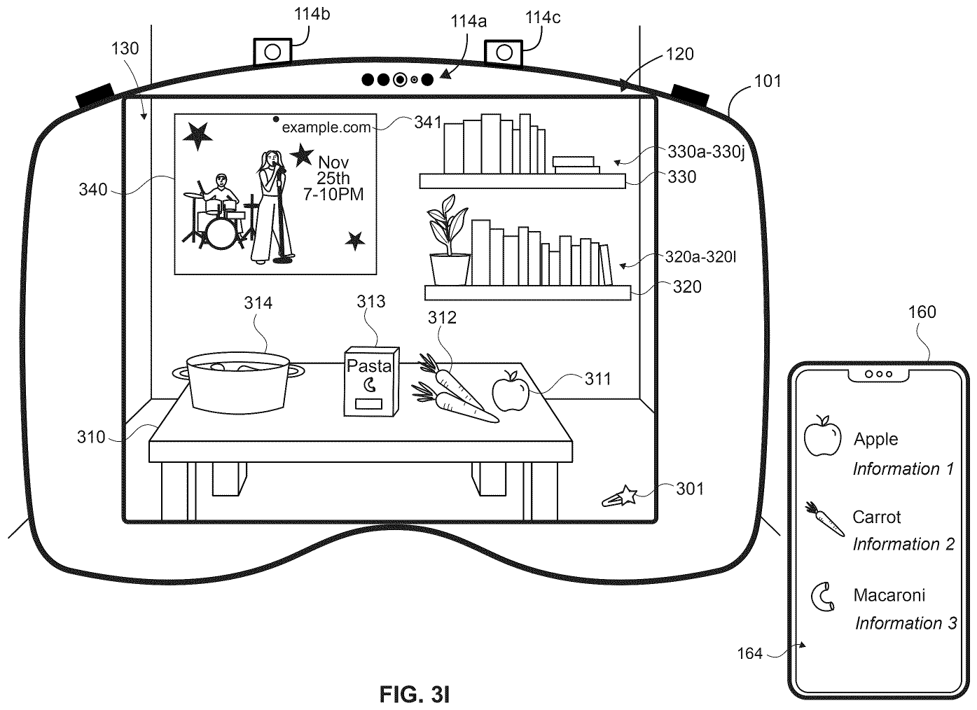

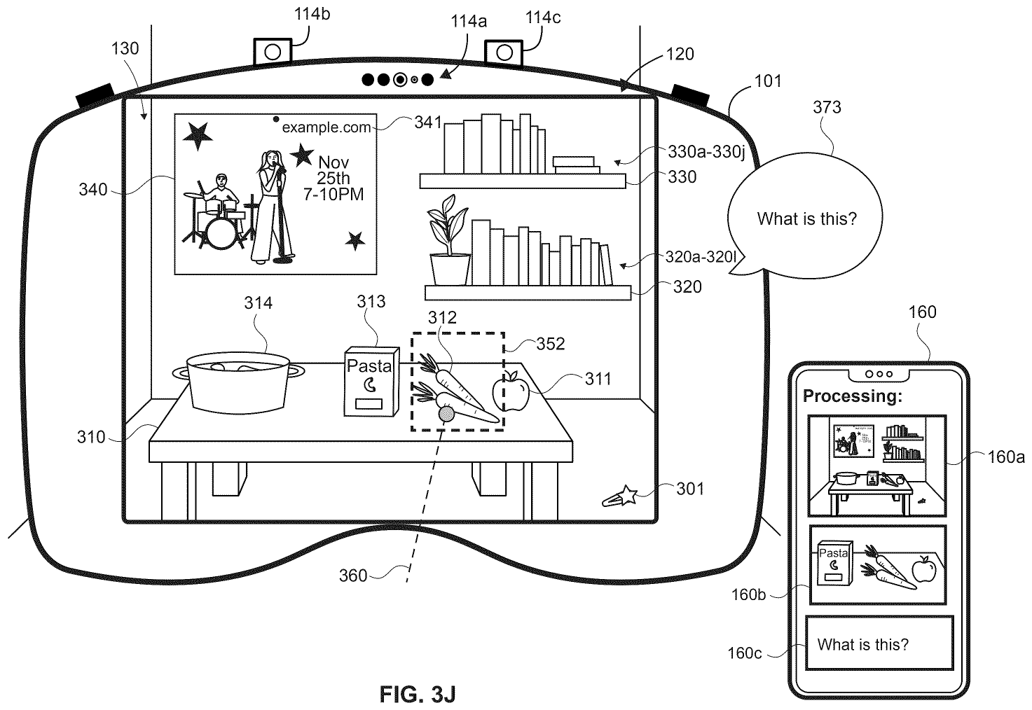

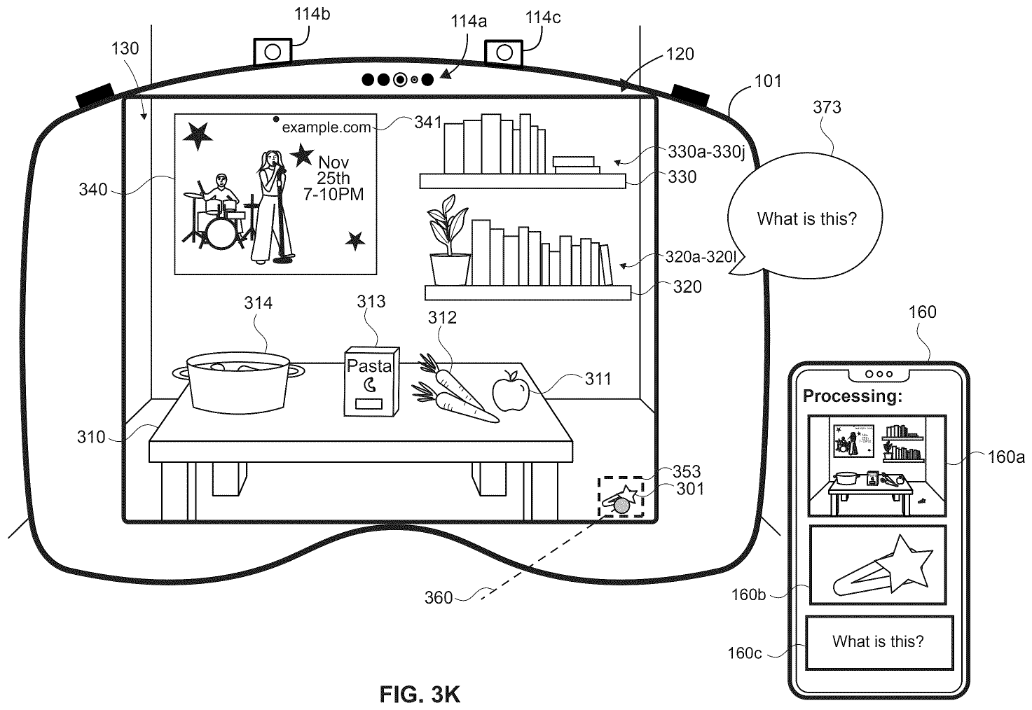

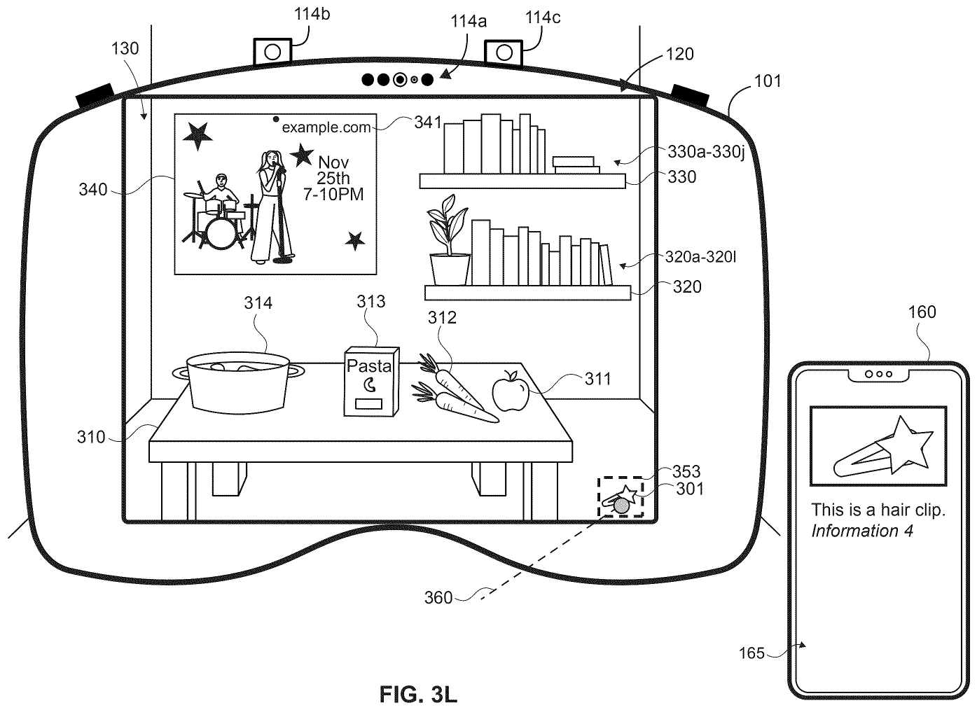

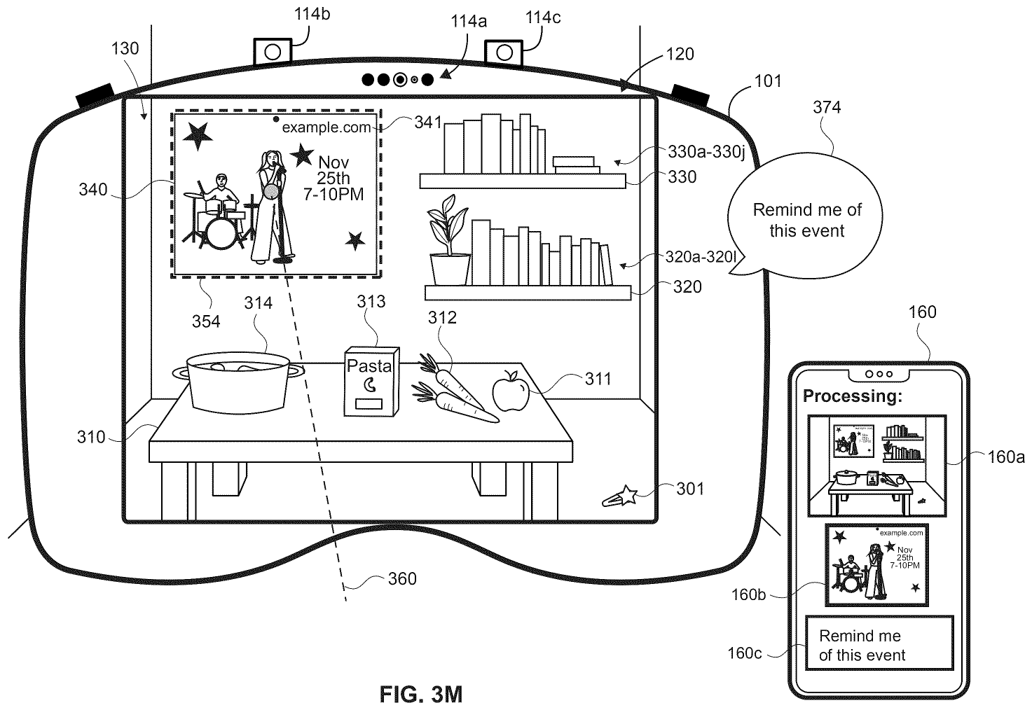

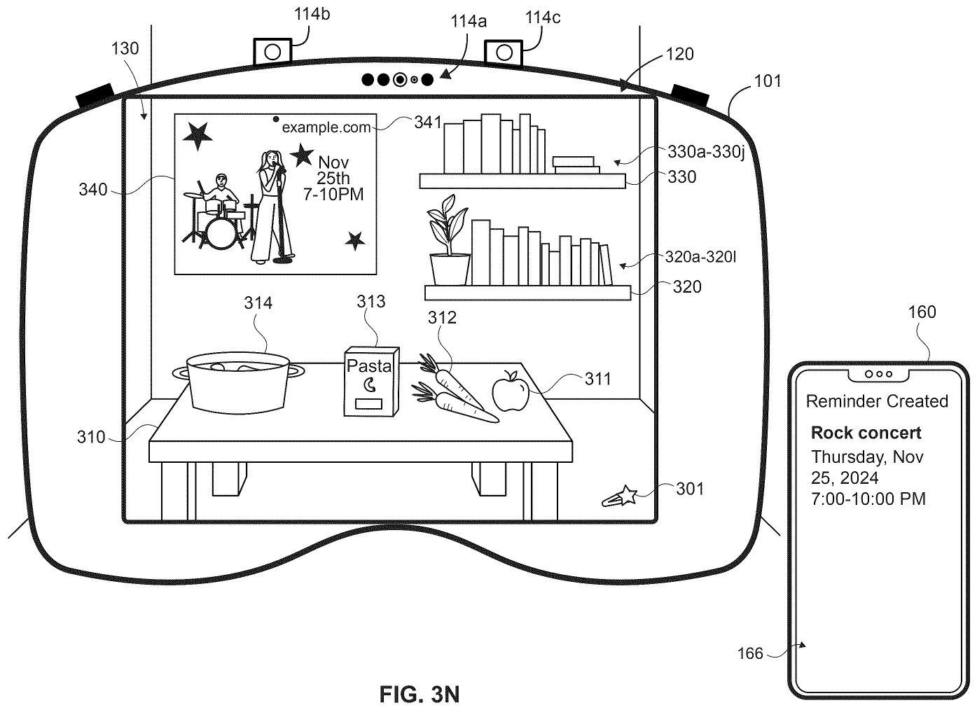

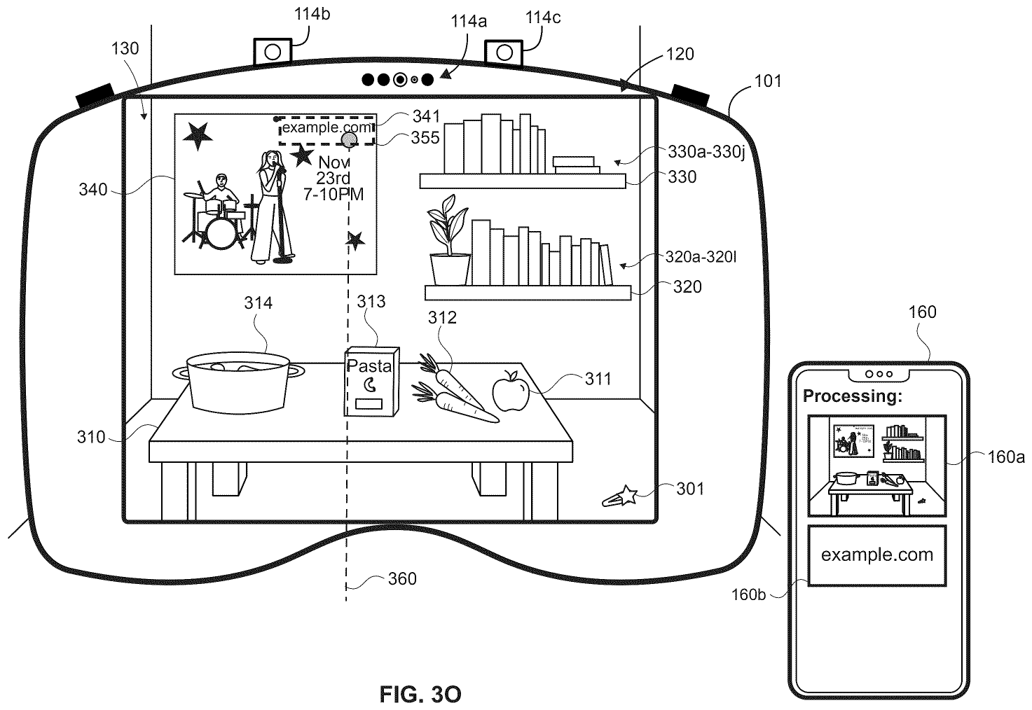

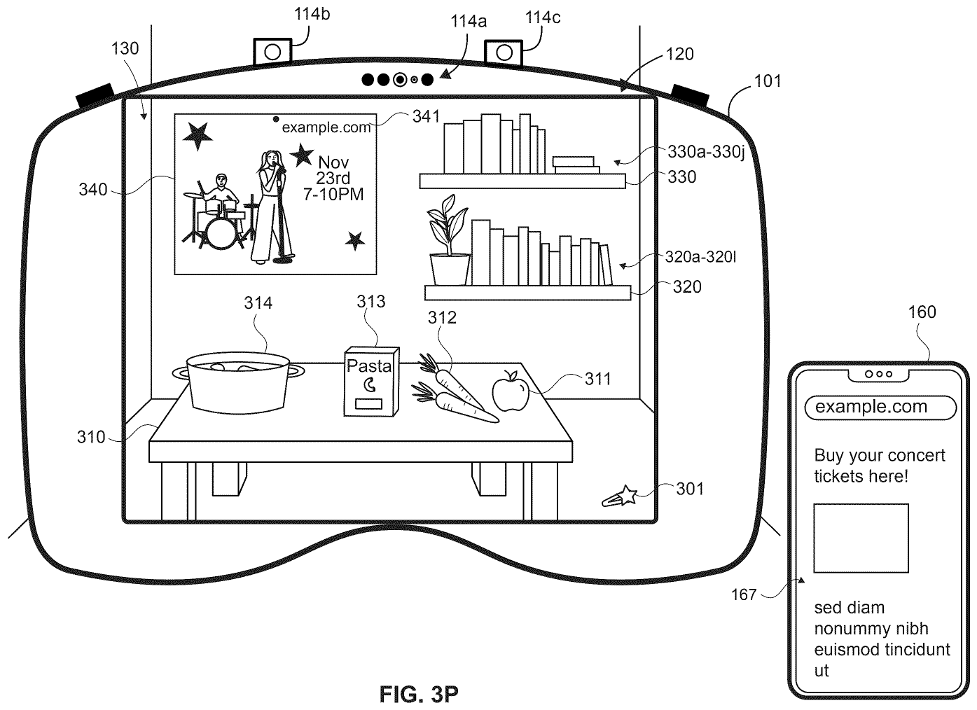

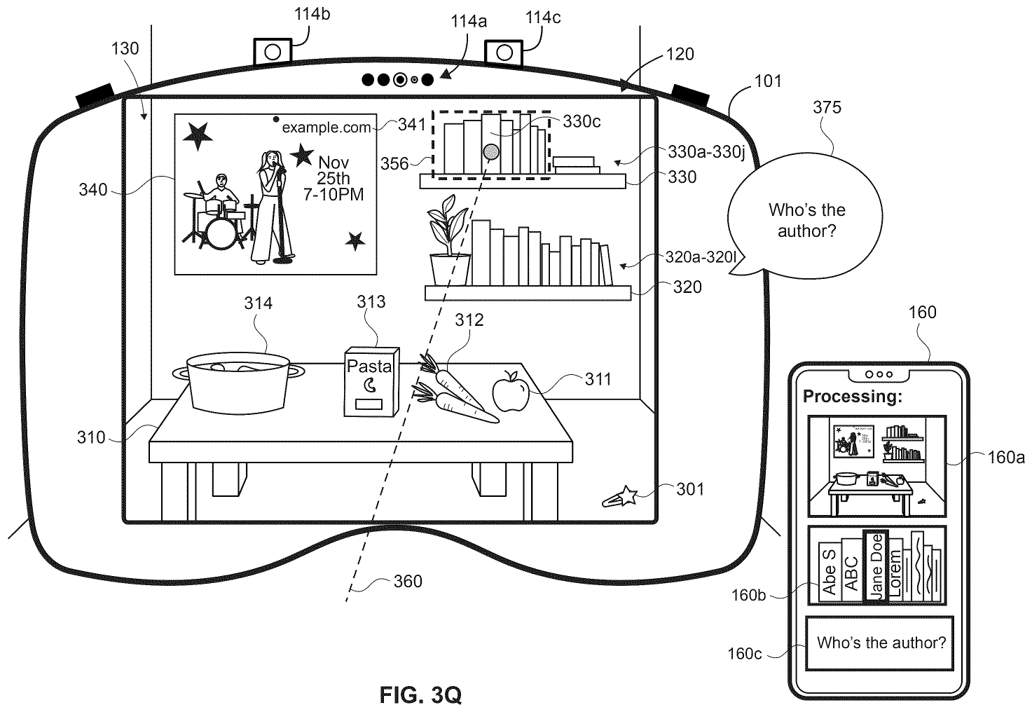

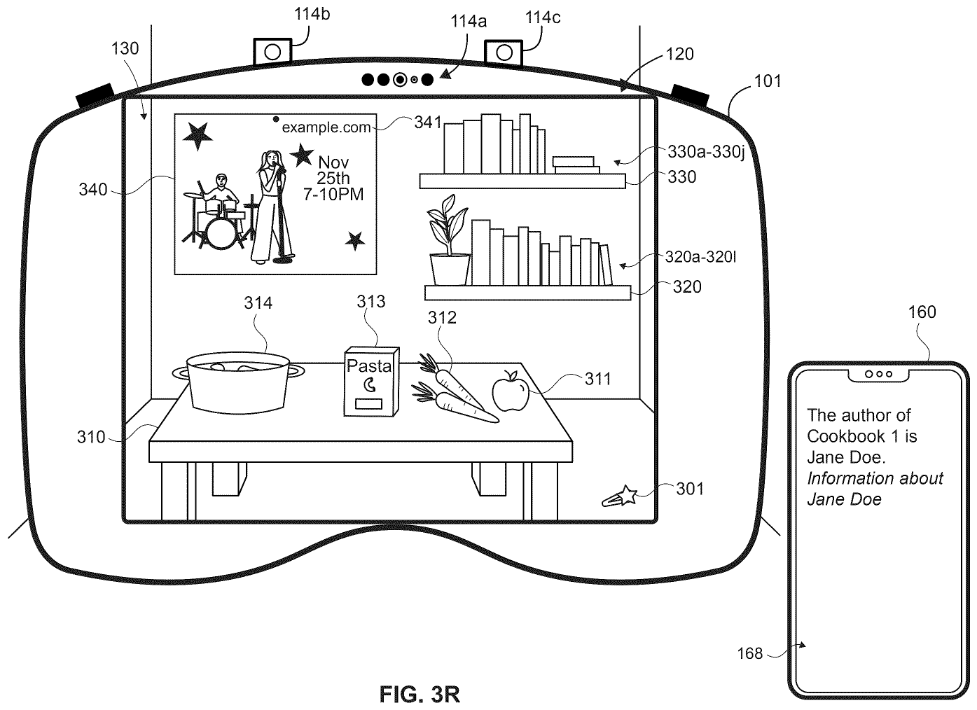

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and various objects (discussed in further detail below) are located in a physical environment (herein labeled as three-dimensional environment 130). The three-dimensional environment 130 may include physical features such as a physical surface (e.g., floor, walls) or a physical object (e.g., table, lamp, etc.). In some examples, electronic device 101 may be configured to detect and/or capture images of the physical environment including table 310 (illustrated in the field of view of electronic device 101 discussed below with reference to FIGS. 3A-3R).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the three-dimensional environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the three-dimensional environment may be directly viewed. In some examples, display 120 may be included within a transparent lens and may overlap all or only a portion of the transparent lens. In other examples, electronic device may be a video-passthrough device in which display 120 is an opaque display configured to display images of the three-dimensional environment captured by external image sensors 114b and 114c. While a single display 120 is shown, it should be appreciated that display 120 may include a stereo pair of displays. In some examples, the head mounted device includes does not include a display 120 (e.g., optionally includes transparent lens), and display functionality is achieved via electronic device 160.

In some examples, the electronic device 101 may be configured to communicate with a second electronic device, such as a companion device. For example, as illustrated in FIG. 1, the electronic device 101 may be in communication with hand-held electronic device 160. In some examples, the hand-held electronic device 160 corresponds to a mobile electronic device, such as a smartphone, a tablet computer, a smart watch, or other electronic device. Additional examples of hand-held electronic device 160 are described below with reference to the architecture block diagram of FIG. 2B. In some examples, the electronic device 101 and the hand-held electronic device 160 are associated with a same user. For example, in FIG. 1, the electronic device 101 may be positioned (e.g., mounted) on a head of a user and the hand-held electronic device 160 may be positioned near electronic device 101, such as in a hand 103 of the user (e.g., the hand 103 is holding of the hand-held electronic device 160), and the electronic device 101 and the hand-held electronic device 160 are associated with a same user account of the user (e.g., the user is logged into the user account on the electronic device 101 and the hand-held electronic device 160). Additional details regarding the communication between the electronic device 101 and the hand-held electronic device 160 are provided below with reference to FIGS. 2A-2B. Although primarily described as a hand-held electronic device herein, it is understood that hand-held electronic device 160 may be a non-hand-held device.

In some examples, while presenting a three-dimensional environment including one or more physical objects, the user of the head mounted device may initiate interaction with one or more physical objects in the three-dimensional environment. In some examples, the interaction can include a user query. In some examples, the interaction can include addition input associated with other input devices. For example, a user's gaze may be tracked by the electronic device as an input for identifying a region of interest corresponding to the one or more physical objects associated with the user inquiry. Additionally or alternatively, in some examples, hand-tracking input can be used for identifying a region of interest corresponding to one or more physical objects.

In the discussion that follows, an electronic device that is in communication with a display generation component and/or one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display generation component and touch-sensitive surface are optionally distributed amongst two or more devices. It should be understood that, in some examples, the electronic device does not include display generation components or a display. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The electronic devices herein can support a variety of applications. For example, the one or more input devices can be used for generating input for interaction with one or more applications and/or the one or more displays can be used for displaying the applications and associated user interfaces. The one or more applications can include one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, head-mounted device, etc., respectively. In some examples, electronic device 201 corresponds to electronic device 101 described above with reference to FIG. 1. In some examples, electronic device 260 corresponds to hand-held electronic device 160 described above with reference to FIG. 1.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable programs including instructions configured to be executed by processor(s) 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B include multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260).

Electronic devices 201 and 260 optionally include image sensor(s) 206A and 206B, respectively. Image sensors(s) 206A, 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A, 206B also optionally include one or more cameras configured to capture movement of physical objects in the real-world environment. Image sensor(s) 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the three-dimensional environment around electronic device 201, 260. In some examples, image sensor(s) 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses image sensor(s) 206A, 206B to detect the position and orientation of electronic device 201, 260 and/or display generation component(s) 214A, 214B in the real-world environment. For example, electronic device 201, 260 uses image sensor(s) 206A, 206B to track the position and orientation of display generation component(s) 214A, 214B relative to one or more fixed objects in the real-world environment.

In some examples, electronic devices 201 and 260 include microphone(s) 213A and 213B, respectively, or other audio sensors. Electronic device 201, 260 optionally uses microphone(s) 213A, 213B to detect sound from the user and/or the real-world environment of the user. In some examples, microphone(s) 213A, 213B includes an array of microphones (a plurality of microphones) that optionally operate in tandem, such as to identify ambient noise or to locate the source of sound in space of the real-world environment.

In some examples, electronic devices 201 and 260 include location sensor(s) 204A and 204B, respectively, for detecting a location of electronic device 201A and/or display generation component(s) 214A and a location of electronic device 260 and/or display generation component(s) 214B, respectively. For example, location sensor(s) 204A, 204B can include a global positioning system (GPS) receiver that receives data from one or more satellites and allows electronic device 201, 260 to determine the device's absolute position in the physical world.

In some examples, electronic devices 201 and 260 include orientation sensor(s) 210A and 210B, respectively, for detecting orientation and/or movement of electronic device 201 and/or display generation component(s) 214A and orientation and/or movement of electronic device 260 and/or display generation component(s) 214B, respectively. For example, electronic device 201, 260 uses orientation sensor(s) 210A, 210B to track changes in the position and/or orientation of electronic device 201, 260 and/or display generation component(s) 214A, 214B, such as with respect to physical objects in the real-world environment. Orientation sensor(s) 210A, 210B optionally include one or more gyroscopes and/or one or more accelerometers.

In some examples, electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A. In some examples, electronic device 201 alternatively does not include hand tracking sensor(s) 202 and/or eye tracking sensor(s) 212. In some such examples, the display generation component(s) 214A may be utilized by the electronic device 260 to provide an extended reality environment and utilize input and other data gathered via the other sensor(s) (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the processor(s) 218B of the electronic device 260. Additionally or alternatively, electronic device 201 optionally does not include other components shown in FIG. 2B, such as location sensors 204B, image sensors 206B, touch-sensitive surfaces 209B, etc. In some such examples, the display generation component(s) 214A may be utilized by the electronic device 260 to provide an extended reality environment and the electronic device 260 utilize input and other data gathered via the one or more motion and/or orientation sensors 210A (and/or one or more microphones 213A) of the electronic device 201 as input.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 include at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and Configuration of FIGS. 2A-2B, but can include fewer, other, or additional components in multiple Configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device. In some examples, electronic device 201 does not include a display and electronic device 260 includes a display.

Attention is now directed towards interactions with the one or more objects in a three-dimensional environment 130. One or input devices of an electronic device (e.g., corresponding to electronic device 201) can be used to support the interactions. As described herein the interactions can include a user query (e.g., text or audio-based natural language request) and/or can include one or more images optionally including one or more images captured by cameras and/or one or more subsets of the image based on user gaze.

FIG. 3A illustrates the electronic device 101 presenting the three-dimensional environment 130 including a plurality of objects corresponding to physical objects within a physical environment (e.g., the physical environment discussed above with reference to FIG. 1). In some examples, the plurality of objects includes the table 310 in the three-dimensional environment 130 positioned centrally within the field of view of the electronic device 101. In some examples, the table 310 optionally includes a plurality of cooking ingredients and/or cooking apparatuses. In some examples, the plurality of cooking ingredients includes, on a first portion of the table 310, apple 311, carrots 312, and pasta 313. In some examples, as shown in FIG. 3A, the first portion of the table 310 on which the aforementioned cooking ingredients are positioned corresponds to a top portion (e.g., surface) of the table 310 that is to the right of center of the field of view of the electronic device 101. In some examples, the table 310 additionally includes pot 314 on a second portion (e.g., different from the first portion) of the table 310. In some examples, as shown in FIG. 3A, pot 314 includes one or more ingredients suspended within a solution (e.g., chicken soup). In some examples, as shown in FIG. 3A, the second portion of the table 310 on which the pot 314 is positioned corresponds to a top portion (e.g., surface) of the table 310 that is to the left of the field of view of the electronic device 101. The first portion and the second portion of the table 310 are not necessarily restricted to the right side and the left side, respectively, of center of the field of view of the electronic device 101, and may be optionally displayed in various alternative combinations of positions on the table 310 relative to the point of view of the electronic device 101.

In some examples, as shown in FIG. 3A, the three-dimensional environment 130 includes hairpin 301 placed on the floor of the physical environment. In some examples, hairpin 301 optionally corresponds to any of a plurality of small hair-related apparatuses. For example, hairpin 301 is optionally a hair tie, bobby pin, claw clip, etc. In some examples, as shown in FIG. 3A, the electronic device 101 displays the hairpin 301 on a floor of the three-dimensional environment 130. This placement optionally corresponds to a bottom right portion of the field of view of the electronic device 101.

In some examples, the three-dimensional environment 130 includes a plurality of objects disposed on a wall of the physical environment corresponding to the three-dimensional environment 130. In some examples, as shown in FIG. 3A, the wall includes poster 340 at an upper left portion of the three-dimensional environment 130 relative to the point of view of the electronic device 101. This poster 340 optionally includes details corresponding to a concert (e.g., images of a drummer and singer as shown in FIG. 3A), as well as website address 341 associated with the poster. In some examples, electronic device 101 performs an operation associated with website address 341 in response to a user input (e.g., user gaze, user hand movement) described in further detail below with reference to FIG. 3O. In some examples, as shown in FIG. 3A, the wall of the physical environment includes lower shelf 320 and upper shelf 330 mounted on a right-side portion of the wall relative to the point of view of the electronic device 101. On each of the respective shelves may be a plurality of books. For example, as shown in FIG. 3A, lower shelf 320 includes books 320a-320l and upper shelf 330 includes books 330a-330j. In some examples, the arrangements of the respective books of a respective shelf are not limiting and may be arranged in any particular order with respect to a respective grouping of books of a respective shelf.

FIG. 3B illustrates the electronic device 101 detecting a user gaze 360 directed at the pot 314 and performing a crop of an image of the three-dimensional environment 130 (e.g., crop 350) while the user gaze 360 is directed the pot 314. In some examples, the electronic device 101 detects the user gaze 360 via one or more input devices. For example, the one or more input devices correspond to the one or more internal image sensors 114a of FIG. 1 and detect a direction of the user gaze 360. In some examples, while the one or more internal image sensors 114a detect the direction of the user gaze 360, electronic device 101 correlates, via the external image sensors 114b and/or 114c, the direction of the gaze 360 with a physical object in the three-dimensional environment 130. In some examples, gaze 360 is directed towards one or more physical objects as discussed in further detail below. In some examples, gaze 360 is directed towards a singular physical object as shown in FIG. 3B. In some examples, the electronic device 101 crops a static image of the three-dimensional environment 130 to produce crop 350. In some examples, the electronic device 101 crops a live-video feed of the three-dimensional environment 130 to produce crop 350. In some examples, the electronic device 101 performs the crop in response to any of the one or more internal image sensors 114a-114c detecting the user gaze 360. For example, as shown in FIG. 3B, the one or more internal image sensors 114a-114c detect gaze 360 directed at a center point of the pot 314 while the electronic device 101 outlines a subsection (e.g., illustrated by dashed box shown in FIG. 3B) of the three-dimensional environment 130 corresponding to the crop 350. In some examples, the electronic device 101 performs the crop after detecting gaze 360. In some examples, crop 350 is produced concurrently with the detection of the gaze 360. In some examples, the electronic device produces the crop 350 according to a predetermined radius and/or distance from the gaze 360. It should be understood that crop 350 may be a variety of shapes (e.g., circle, square, triangle, star, etc.) corresponding to the subsection of the three-dimensional environment 130 and is not necessarily limited to the rectangular shape as illustrated in FIG. 3B.

In some examples, electronic device 101 detects the physical object corresponding to the direction of the gaze 360 and determines a subsection of the three-dimensional environment 130 that encapsulates the entirety of physical object. In some examples, the electronic device performs the crop 350 according to a user input discussed in further detail below. In some examples, the electronic device 101 processes an image of the three-dimensional environment 130 and the direction of the user gaze 360 prior to determining one or more boundaries of the crop 350. At least one of the aforementioned inputs are optionally processed by a large language learning model to determine the one or more boundaries of the crop 350 discussed in further detail below with reference to FIG. 3C. In some examples, the electronic device 101 processes the image of the three-dimensional environment 130 and determines the one or more boundaries of the crop 350 via a machine learning model (e.g., neural network, deep learning, etc.) at the electronic device 101. In some examples, the electronic device 101 transmits the image of the three-dimensional environment 130 to a secondary electronic device (not pictured) such as a server, desktop computer, and/or a cloud-based electronic service. At this secondary electronic device is optionally stored a machine learning model including one or more characteristics of the machine learning model discussed above configured to process the image of the three-dimensional environment 130 and determine the one or more boundaries of the crop 350.

FIG. 3C illustrates a detection of a user voice command 370 while the user gaze 360 is directed at pot 314 within crop 350 in the three-dimensional environment 130, and while the hand-held electronic device 160 processes the captured images of the three-dimensional environment 130, crop 350, and the user voice command 370 according to some examples of this disclosure. In some examples, FIG. 3B and FIG. 3C occur concurrently. In some examples, as shown in FIG. 3C, the electronic device 101 detects the voice command 370 while detecting the direction of the user gaze 360. In some examples, the voice command 370 corresponds to a vocal command spoken by the user of the electronic device 101. In some examples, the voice command 370 optionally corresponds to a vocal command spoken by a secondary user, different than the user of the electronic device 101. In some examples, the voice command 370 is detected by microphone(s) 213A, 213B discussed above with reference to FIGS. 2A-2B and transmitted, as input data, to the hand-held electronic device 160.

In some examples, the electronic device 101 transmits data corresponding to the image of the three-dimensional environment 130, crop 350, and the voice command 370 to hand-held electronic device 160. In some examples, the hand-held electronic device 160 includes at least one or more characteristics of the secondary electronic device discussed above with reference to FIG. 3B. In some examples, the electronic device 101 processes the aforementioned inputs as inputs 160a-160c. In some examples, as shown by FIG. 3C, the hand-held electronic device 160 processes inputs 160a-160c while user gaze 360 is directed towards pot 314. In some examples, the hand-held electronic device 160 processes inputs 160a-160c via an internal machine learning model. In particular, input 160c optionally corresponds to the voice command 370 detected by the electronic device 101 and is optionally processed by a large language learning model at the hand-held electronic device 160. In some examples, the hand-held electronic device 160 processes the inputs 160a-160c via machine learning models stored at the hand-held electronic device 160. In some examples, the hand-held electronic device 160 transmits one or more of inputs 160a-160c to be processed at a third electronic device (not shown). The remaining inputs are optionally processed at the hand-held electronic device 160.

FIG. 3D illustrates a detection of the user voice command 370 paired with hand press 380 (or other touch input) while the user gaze 360 is directed at pot 314 within crop 350 in the three-dimensional environment 130, and while the hand-held electronic device 160 processes data corresponding to the three-dimensional environment 130, crop 350, and the user voice command 370 paired with hand press 380 according to some examples of this disclosure. In some examples, FIG. 3D illustrates an alternative example process of capturing crop 350 to that outlined above with reference to FIG. 3C. As discussed above with reference to FIG. 3C, the electronic device 101 optionally detects user voice command 370 and, in response, captures the image of the three-dimensional environment 130 (e.g., additionally illustrated by input 160a). In some examples, as illustrated in FIG. 3D, the electronic device 101 optionally requires the additional hand press 380 as a trigger to capture the image of the three-dimensional environment 130. In some examples, the electronic device 101 detects hand press 380 and the user voice command 370 concurrently. In some examples, the electronic device 101 determines the hand press 380 as a valid input if the input is detected within a threshold time (e.g., 0.1 seconds, 0.25 seconds, 0.5 seconds, 0.75 seconds, 1 second, etc.) of detecting the user voice command 370 (e.g., before or after detection). This hand press 380 optionally corresponds to the user of the electronic device 101 but is not limited to any specific user. For example, the electronic device 101 optionally detects hand press 380 administered by a user of a third electronic device.

FIG. 3E illustrates an alternative example process of detecting a user command (e.g., similar to voice command 370) via a text input 377, while the user gaze 360 is directed at the pot 314 encapsulated by crop 350 within the three-dimensional environment 130 according to some examples of this disclosure. In some examples, the alternative process shown in FIG. 3E includes one or more characteristics of the process of detecting the user command as shown by FIGS. 3C and/or 3D. In some examples, while the user gaze 360 is directed at the pot 314, the hand-held electronic device 160 detects the text input 377 directed towards a keyboard as illustrated by FIG. 3E. In response to detecting this input, the hand-held electronic device 160 optionally displays a visual representation 377a of the text input 377. For example, as shown in FIG. 3E, hand-held electronic device 160 optionally detects text input 377 on a digital keyboard of the hand-held electronic device 160, and in response, displays the visual representation 377a of the text input 377 at the hand-held electronic device 160 (e.g., “Set timer for 1 hour and 25 minutes”). In some examples, the text input 377 includes one or more characteristics of the user voice command 370 as discussed above. In some examples, the hand-held electronic device 160 does not display the visual representation 3757 of the text input 377, instead processing the respective command as similarly shown above with reference to input 160c in FIG. 3D. For example, the hand-held electronic device 160 processes inputs 160a-160b as shown above and processes text input 377 as input 160c in a similar manner as the user voice command 370 as illustrated above. As a result of the above-described inputs and commands, the hand-held electronic device 160 optionally performs an operation associated with the inputs and commands as discussed in further detail below.

FIG. 3F illustrates a timer 162 associated with pot 314 presented at the hand-held electronic device 160 in response to a user input (e.g., user voice command 370, text input 377), while the electronic device 101 presents the three-dimensional environment 130 according to some examples of this disclosure. In some examples, the timer 162 automatically begins a countdown from the time set by the above discussed input in response to the hand-held electronic device 160 processing inputs 160a-160c. In some examples, as shown in FIG. 3F, the timer 162 is displayed as a text box disposed in an upper portion of the hand-held electronic device 160. In some examples, the hand-held electronic device 160 initiates timer 162 associated with pot 314 but does not display the timer 162. In some examples, the hand-held electronic device communicates the timer 162 to the electronic device 101 for storage and/or a command to perform the operation (e.g., running timer 162) at the electronic device 101. In some examples, the electronic device continues to detect a direction of a user gaze (e.g., user gaze 360) while the hand-held electronic device 160 displays timer 162. In some examples, electronic device 101 and/or hand-held electronic device 160 are configured to run a plurality of operations in response to the user voice command 370 or the text input 377. For example, while the electronic device 101 and/or the hand-held electronic device 160 run timer 162, the electronic device optionally detects user gaze 360 as discussed in further detail below. In another example, while the electronic device 101 and/or the hand-held electronic device 160 run timer 162, the electronic device optionally performs any of the operations as outlined above with reference to FIGS. 3A-3F.

FIG. 3G illustrates an infographic user interface 163 associated with the pot 314 within crop 350 in the three-dimensional environment 130, the infographic user interface 163 presented at the hand-held electronic device 160 in response to a user voice command 371 (e.g., “What can I cook with this?”), while the electronic device 101 presents the three-dimensional environment 130 and while detecting user gaze 360 according to some examples of this disclosure. In some examples, as shown in FIG. 3G, the electronic device 101 detects the user voice command 371, and in response, performs a crop 350 akin to the cropping operation discussed above to an image of the three-dimensional environment 130. In some examples, the electronic device 101 transmits data corresponding to the image of the three-dimensional environment 130, the user voice command 371, and the crop 350 to the hand-held electronic device 160 for processing in a similar manner as discussed above with reference to FIG. 3D. In some examples, the image of the three-dimensional environment 130, the user voice command 371, and the crop 350 correspond to inputs 160a-160c discussed above with reference to FIG. 3D. In some examples, the hand-held electronic device 160 processes the aforementioned inputs and in response, presents the infographic user interface 163, described below.

In some examples, as shown in FIG. 3G, the infographic user interface 163 includes information related to pot 314 and/or its contents (e.g., “Recipe ideas including chicken soup”). For example, after determining the user voice command 371 is associated with the pot 314 within crop 350, the hand-held electronic device 160 presents, as shown in FIG. 3G, a list of recipes (e.g., “Recipe A”, “Recipe B”) associated with chicken soup within the infographic user interface 163. In some examples, the information presented at the infographic user interface 163 associated with the pot 314 includes, but is not necessarily limited to, ingredients present within the three-dimensional environment 130. For example, the electronic device 101 optionally detects (e.g., via image sensors 114b and 114c) pasta 313, carrot 312, and/or apple 311 within the three-dimensional environment 130 and optionally includes these objects as ingredients in suggested recipes displayed at the infographic user interface 163. In some examples, the infographic user interface includes one or more items not corresponding to the one or more physical objects (e.g., apple 311) within the three-dimensional environment 130. For example, the hand-held electronic device 160 optionally determines the presence of a shopping list (not shown), optionally stored at the hand-held electronic device 160 (e.g., stored within memory of the hand-held electronic device 160 and/or associated with an application of the hand-held electronic device 160, such as a note-taking and/or text-editing application or a photos application), and optionally presents one or more recipes at the infographic user interface 163 that include the one or more ingredients within the shopping list.

FIG. 3H illustrates the electronic device 101 detecting a user voice command 372 and performing crop 351 of an image of the three-dimensional environment 130 while the user gaze 360 is directed toward a plurality of objects (e.g., pasta 313, carrot 312, apple 311) in the three-dimensional environment 130, and illustrates the hand-held electronic device 160 processing the image of the three-dimensional environment 130, the crop 350 including the plurality of objects, and the user voice command 372 according to some examples of this disclosure. In some examples, the hand-held electronic device 160 processes the voice command 372 (e.g., “What are these?”) using a machine learning model as discussed previously above. Using this model, the electronic device 101 is optionally able to determine, using the direction of the user gaze 360, the crop 351, and the voice command 372, that the user's detected voice command 372 is most likely referring to pasta 313, carrot 312, and apple 311, and perform a subsequent operation associated with the aforementioned items. In some examples, the electronic device 101 performs the crop 351 according to a predetermined radius and/or distance from the center of the direction of the user gaze 360 that includes the pasta 313, carrot 312, and apple 311. In some examples, the electronic device 101 determines the boundaries of the crop 351 according to a detection of one or more objects in the vicinity of the direction of the user gaze 360. For example, as shown in FIG. 3H, the electronic device 101 optionally detects the pasta 313, carrot 312, and apple 311 and optionally determines a distance from each object to the direction of the user gaze 360. If a respective object is within a threshold distance from the direction of the user gaze 360 and optionally within a threshold distance between each respective object, the electronic device 101 optionally includes the identified objects in the crop 351. In some examples, the electronic device 101 transmits data corresponding to the image of the three-dimensional environment 130, the crop 351, and the user voice command 372 to be processed as inputs 160a though 160c at the hand-held electronic device 160. In some examples, in response to processing inputs 160a through 160c, the hand-held electronic device 160 performs an operation associated with the user voice command 372 as discussed in further detail below.

FIG. 3I illustrates an alternative example of the electronic device 101 presenting the three-dimensional environment 130 while the hand-held electronic device 160 presents a list of items 164 associated with the plurality of items discussed above, according to some examples of this disclosure. In some examples, as shown in FIG. 3I, the list of items 164 includes representations of the plurality of items (e.g., pasta 313, carrot 312, and apple 311 in FIG. 3H) and information associated with each respective item. For example, the detection of the user voice command 372, as shown in FIG. 3H, initiates an operation to describe the plurality of items. In response to processing inputs 160a through 160c, as described above, the hand-held electronic device 160 optionally displays a representation of the apple 311 and optionally includes a subsection of an online website associated with the apple 311 (e.g., an online encyclopedia, Food and Drug Administration Nutrition guidelines, etc.). In some examples, as shown in FIG. 3I, the list of items 164 includes a corresponding description associated with each of the plurality of items described above in no particular order. In some examples, the list of items 164 includes one or more hyperlinks associated with the plurality of items configured to receive a user input, such as a selection of the one or more hyperlinks.

FIGS. 3J-3K illustrate examples of a detection of a user voice command 373 while the user gaze 360 is directed at an object (e.g., carrot 312 and hairpin 301, respectively) within a cropped region (e.g., crop 352 and crop 353, respectively) in the three-dimensional environment 130 according to some examples of this disclosure, and while the hand-held electronic device 160 processes the image of the three-dimensional environment 130, the cropped image of the object (crop 352 or crop 353), and the user voice command 373 according to some examples of this disclosure.

In some examples, the electronic device 101 detects a direction of the user gaze 360 as being directed towards a region associated with the crop 351 previously discussed above with reference to FIG. 3H. In some examples, the direction of the user gaze 360 as shown in FIG. 3J includes one or more characteristics of the direction of the user gaze 360 as previously shown in FIG. 3H. In some examples, as shown in FIG. 3J, the electronic device 101 determines, via a machine learning model, the user voice command 373 corresponds to the carrot 312 and produces crop 352 from the image of the three-dimensional environment 130. For example, the user voice command 372 of FIG. 3H optionally includes the phrase “these” while the user voice command 373 of FIG. 3J optionally includes the phrase “this. ” Via a combination of the machine learning model and the direction of the user gaze 360, the electronic device 101 is configured to optionally detect an intention of the user of the electronic device 101 to select a group of objects, as shown in FIG. 3H, or an intention to select an object from a group of objects, as shown in FIG. 3J. In some examples, the electronic device 101 transmits data corresponding to the image of the three-dimensional environment 130, the crop 352 including the carrot 312, and the user voice command 373 to the hand-held electronic device 160 as inputs 160a through 160c for processing and implementing a subsequent operation in a similar fashion as described above.

In some examples, as shown in FIG. 3K, the electronic device 101 determines the direction of the user gaze 360 as being towards hairpin 301 and performs crop 353 on the image of the three-dimensional environment 130. For example, the electronic device 101 detects that the gaze 360 has moved from being directed to the carrot 312 to being directed to the hairpin 301. In some examples, the electronic device 101 detects a portion of the user voice command 373 (e.g., “this”) and draws an association with the hairpin 301 in a similar fashion to the process outlined above with reference to FIG. 3J. In some examples, the electronic device 101 transmits data corresponding to the image of the three-dimensional environment 130, the crop 353, and the user voice command 373 to the hand-held electronic device 160 in a similar fashion as described above with reference to FIG. 3J. In some examples, the hand-held electronic device 160 processes inputs 160a through 160c and performs an operation associated with the user voice command 373 as illustrated by FIG. 3L.

In some examples, as shown in FIG. 3L, the electronic device 101 presents the three-dimensional environment 130, while the hand-held electronic device 160 presents an infographic user interface 165 associated with the hairpin 301. In some examples, the infographic user interface 165 includes one or more characteristics of the infographic user interface 163 discussed above with reference to FIG. 3G. For example, as shown in FIG. 3G and FIG. 3L, the hand-held electronic device 160 optionally displays a representation of an object (e.g., representation of the hairpin) within the respective cropped image (e.g., crop 350, crop 353) and text information associated with the respective object (e.g., information identifying the hairpin 301 as a hair clip). In some examples, as shown in FIG. 3L, the electronic device 101 displays the three-dimensional environment 130 and the hand-held electronic device 160 displays the infographic user interface 165 concurrently but can optionally be displayed at nonconcurrent times.

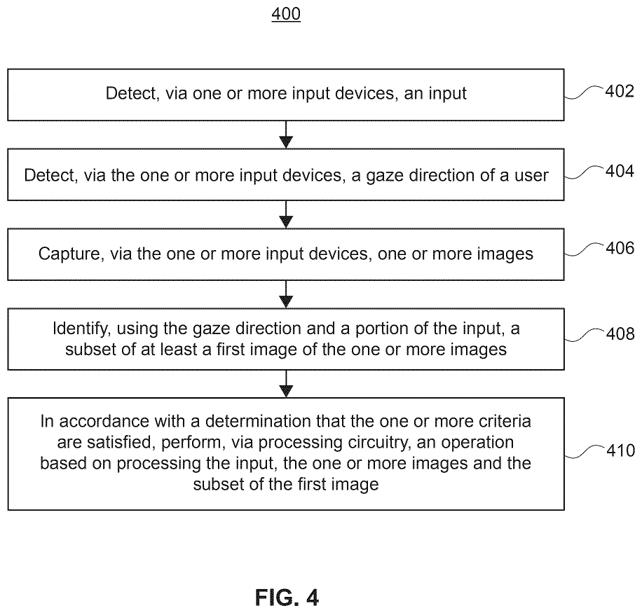

FIG. 3M illustrates the electronic device 101 detecting a user voice command 374 and performing a crop (e.g., crop 354) of an image of the three-dimensional environment 130 based on a direction of the user gaze 360 corresponding to the poster 340, and while the hand-held electronic device 160 processes the image of the three-dimensional environment 130, the crop 354, and the user voice command 374 according to some examples of this disclosure. In some examples, as shown in FIG. 3M, the hand-held electronic device 160 determines (optionally via any suitable machine learning algorithm) an association between at least a portion of the user voice command 374 (e.g., “this”) and text within a subsection of the crop 354 (e.g., “November 25^{th} 7-10 pm”). In some examples, as shown in FIG. 3M, the electronic device 101 detects the direction of the user gaze 360 as being directed at poster 340 and produces crop 354 containing the entirety of poster 340. In some examples, the electronic device 101 detects text in the subsection of crop 354, independent of the direction of the gaze 360. For example, as shown in FIG. 3M, the electronic device 101 optionally detects the user gaze 360 direction as pointed towards a band member illustrated by poster 340. In response, the electronic device 101 optionally performs crop 354 and optionally determines text associated with the user voice command 374 (e.g., “November 25^{th} 7-10 pm”). Once this text is detected, the electronic device 101 optionally transmits data corresponding to the subsection of the crop 354 as input 160b to the hand-held electronic device 160. In some examples, the at least a portion of the user voice command 374 corresponds to “a portion of an input” discussed in further detail below with reference to block 408 of FIG. 4. In some examples, the image of the three-dimensional environment 130, the crop 354, and the user voice command 374 correspond to inputs 160a through 160c and are processed in a similar manner to perform an operation as similarly discussed above with reference to FIGS. 3A-3L. In some examples, the hand-held electronic device 160 performs an operation associated with the poster 340 as discussed in further detail below.

FIG. 3N illustrates an example of an operation associated with the poster 340 at the hand-held electronic device 160 being performed while the electronic device 101 displays the three-dimensional environment 130 according to some examples of this disclosure. In some examples, as a result of receiving the inputs 160a through 160c as discussed above with reference to FIG. 3M, the hand-held device adds and/or creates a reminder 166 to the user's calendar. In some examples, this reminder is stored at the hand-held electronic device 160, the electronic device 101, and/or a secondary computer/serve in communication with either electronic device. In some examples, as shown in FIG. 3N, the hand-held electronic device 160 displays the reminder 166 as a text entry that includes the text found within crop 354 shown above with reference to FIG. 3M. In some examples, the reminder 166 is added and stored at the hand-held electronic device 160 but is not displayed. In some examples, in response to successfully creating the reminder, the hand-held electronic device 160, as shown in FIG. 3N, displays a notification (e.g., “Reminder Created”) at an upper portion of the display of the hand-held electronic device 160. In some examples, the hand-held electronic device 160 does not require a user input to perform an operation associated with an object (e.g., poster 340) as discussed in further detail below.

FIG. 3O illustrates the electronic device 101 detecting the user gaze 360 directed at the website address 341 at the poster 340 within a cropped region (e.g., crop 355) in the three-dimensional environment 130, while the hand-held electronic device 160 processes the image of the three-dimensional environment 130 and the website address 341 according to some examples of this disclosure. In some examples, in response to detecting the direction of the user gaze 360 at the website address 341, the hand-held electronic device 160 automatically processes the image of the three-dimensional environment 130 (optionally corresponding to input 160a) and the crop 355 containing the website address 341 (optionally corresponding to input 160b) without the need of a user input. In some examples, as shown by FIG. 3P, the hand-held electronic device 160 displays a website 167 associated with the website address 341 and/or the poster 340. In some examples, as shown by FIG. 3P, the website 167 includes interactable components (e.g., “Buy your concert tickets here!”) configured to initiate further operations associated with the poster 340 (e.g., purchase tickets). In some examples, the electronic device 101 performs any of the methods and/or operations associated with FIGS. 3A through 3N while the hand-held electronic device 160 displays the website 167.

FIG. 3Q illustrates the electronic device 101 detecting a user voice command 375 while the user gaze 360 is directed at books 330a through 330j and performs a cropping (e.g., crop 356) of a portion of the upper shelf 330 within the image of the three-dimensional environment 130, and while the hand-held electronic device 160 processes the image of the three-dimensional environment 130, a book 330c within crop 356, and the user voice command 375 according to some examples of this disclosure. In some examples, the aforementioned items correspond to inputs 160a through 160c at the hand-held electronic device 160. In some examples, the hand-held electronic device 160 processes the inputs 160a through 160c in a similar manner as described above with reference to FIGS. 3A through 3O. In some examples, the hand-held electronic device 160 determines a respective book (e.g., book 330c) of the books 330a though 330j within the crop 356 based on a combination of the user voice command 375 and the direction of the user gaze 360. In some examples, the inputs 160a through 160c include one or more characteristics of the inputs 160a through 160c associated with any of the FIGS. 3A through 3O. In some examples, in response to processing the inputs 160a through 160c, the hand-held electronic device 160 presents information associated with the book 330c as discussed in further detail below.

FIG. 3R illustrates an infographic user interface 168 associated with the book within the cropped region in the three-dimensional environment 130 and that is presented at the hand-held electronic device 160 in response to the user voice command, while the electronic device 101 presents the three-dimensional environment 130 according to some examples of this disclosure. In some examples, as shown in FIG. 3R, the hand-held electronic device 160 displays information associated with the author (e.g., in infographic user interface 168) of book 330c while providing information about the author that is relevant to previous operations performed by the hand-held electronic device 160. For example, as shown in FIG. 3G, the hand-held electronic device 160 optionally presents the infographic user interface 163 that optionally includes information associated with pot 314. As shown in FIG. 3R, the hand-held electronic device 160 optionally presents the infographic user interface 168 that optionally includes cooking related information associated with the author as a result of previous operations being associated with cooking (e.g., recipe recommendations). In some examples, in response to inputs 160a through 160c of FIG. 3Q, the hand-held electronic device 160 presents a webpage associated with the author (e.g., “Jane Doe”) of book 330c at the infographic user interface 168. In some examples, the hand-held electronic device 160 presents information at the infographic user interface 167 based on on-device stored information (e.g., results of previously performed related operations). Alternatively, in some examples, the hand-held electronic device 160 presents the infographic user interface 168 in response to receiving only inputs 160a through 160c of FIG. 3Q.

FIG. 4 is a flow diagram illustrating a method of performing an operation based on a user query in combination with a cropped image of an object and an image of a three-dimensional environment according to some examples of this disclosure. The method is optionally performed at an electronic device as described above with reference to FIGS. 1-3R (e.g., electronic device 101). Some operations in method 400 are, optionally, combined and/or the order of some operations is, optionally, changed. In some examples, the method 400 comprises five steps (e.g., blocks 402 through 410).

In some examples, block 402 in accordance with the method 400, involves detecting an input according to some examples of this disclosure. In some examples, the input corresponds to gaze 360 described with reference to FIGS. 3A-3R above. In some examples, the detection step is facilitated through the utilization of the one or more internal image sensors 114a-114c positioned to capture the input from the user. For example, the one or more input devices optionally correspond to the one or more internal image sensor 114a discussed above with reference to FIG. 3B. In some examples, the input corresponds to a detection of hand press 380 as discussed above with reference to FIG. 3D. This hand press 380 is optionally performed by hand 103 optionally corresponding to the user of the electronic device 101. In some examples, the input corresponds to sound detected by the electronic device 101. For example, as shown in FIG. 3C, electronic device 101 detects voice command 370 outlining an operation to be performed by the electronic device 101 (e.g., “Set timer for 1 hour and 25 minutes”). In some examples, the input detected by the one or more input devices includes detecting one or more inputs by one or more different input devices. For example, electronic device 101 optionally detects hand press 380 and voice command 370 as discussed above with reference to FIG. 3D via one or more different input devices in communication with the electronic device 101. This capture of an input sets the foundation for subsequent steps of method 400 and the resulting various operations performed by the electronic device 101 in block 410.

In some examples, block 404, in accordance with the method 400, involves detecting a gaze direction of a user according to some examples of this disclosure. In some examples, the gaze direction (e.g., user gaze 360) is detected by the one or more input devices discussed above with reference to block 402. In some examples, the gaze direction includes one or more characteristics of the user gaze 360 as discussed above. In some examples, the gaze direction corresponds to one or more physical objects within the three-dimensional environment 130 as shown above with reference to FIG. 3H. In some examples, in response to the detection of gaze direction, the electronic device 101 performs one or more operations as discussed in further detail below.

In some examples, block 406, in accordance with the method 400, involves capturing one or more images of the three-dimensional environment 130 according to some examples of this disclosure. In some examples, the electronic device 101 captures the one or more images of the three-dimensional environment 130 via the one or more input devices discussed above with reference to block 402. In some examples, the one or more images include the one or more physical objects within the three-dimensional environment 130 discussed above with reference to block 404. In some examples, the electronic device captures the one or more images in response to hand press 380 as discussed above with reference to FIG. 3D. In some examples, the one or more images include at least a first image discussed in further detail below.

In some examples, block 408, in accordance with the method 400, involves identifying a subset (e.g., crop 350) of a first image of the one or more images based on the detected gaze direction and the detected input according to some examples of this disclosure. In some examples, the electronic device 101 identifies the one or more physical objects within the subset based on the detected gaze direction (e.g., user gaze 360). In some examples, the detected input corresponds to any of the user voice commands 370 through 374 as discussed above. In some examples, the electronic device 101 identifies the gaze direction as being associated with a region of the first image. For example, the gaze direction is optionally directed at the upper shelf 330 as shown in FIG. 3Q, and in response, identifies a subsection associated with the region including the upper shelf 330 (e.g., books 330a-330j). In some examples, the electronic device further performs an operation associated with the subsection of the first image as discussed in further detail below with reference to block 410.

In some examples, block 410, in accordance with the method 400, involves performing an operation based on the processed input (e.g., user voice command 372, the processed one or more images (e.g., three-dimensional environment 130), and the subset of the first image (e.g., crop 350) in accordance with a determination that one or more criteria are satisfied according to some examples of this disclosure. In some examples, the electronic device 101 identifies a command to perform an operation (e.g., set timer discussed above in FIG. 3C) from at least a portion of the detected input. For example, the electronic device 101 optionally detects user voice command 373 (e.g., “What is this?”) and corresponds the command to perform an operation with the hairpin 301 as discussed above with reference to FIG. 3K, and in response, performs an operation at the hand-held electronic device 160 to display information such as using an infographic user interface 165 associated with the hairpin 301. In some examples, the one or more criteria are met as a result of the electronic device 101 successfully processing the one or more inputs. In some examples, the electronic device 101 processes the input (e.g., user voice command 370) using a large language learning model as discussed above. In some examples, the electronic device processes the input, the one or more images, and the subsection of the first image sequentially in any order. In some examples, the electronic device processes the input, the one or more images, and the subsection of the first image concurrently. In some examples, the electronic device 101 and/or the hand-held electronic device 160 determines that the one or more criteria are satisfied. In some examples, the one or more criteria are satisfied by the hand-held electronic device 160 determining that the processed input is considered a valid input (e.g., a known command as compared to the large language learning model). In some examples, the hand-held electronic device 160 performs the operation while concurrently performing any of the blocks 402 through 408.

It should be understood that the particular order in which the blocks of the flowchart of FIG. 4 have been described is merely exemplary and is not intended to indicate that the described order is the only order in which the operations could be performed. One of ordinary skill in the art would recognize various ways to reorder the operations described herein.

In some examples, while an electronic device (e.g., electronic device 101) is in communication with one or more one or more input devices (e.g., one or more internal image sensors 114a in FIG. 1), the electronic device detects, via the one or more input devices, an input. In some examples, the electronic device detects, via the one or more input devices, a gaze direction of a user, such as user gaze 360 discussed above with reference to FIG. 3B. In some examples, the electronic device captures, via the one or more input devices, one or more images, such as inputs 160a and 160b as shown by FIG. 3C. In some examples, the electronic device identifies, using the gaze direction and a portion of the input (e.g., voice command 370 shown by FIG. 3C), a subset of at least a first image of the one or more images, such as the crop 350 discussed above with reference to FIG. 3C. In some examples, in accordance with a determination (e.g., by electronic device 101) that one or more criteria are satisfied (e.g., detecting text input 377 shown by FIG. 3E), the electronic device performs, via processing circuitry (e.g., processor(s) 218A, processor(s) 218B), an operation based on processing the input, the one or more images, and the subset of the first image, such as generating timer 162 as discussed above with reference to FIG. 3F.

In some examples, the electronic device identifies the subset of the at least the first image (e.g., input 160a) of the one or more images by, cropping, via the processing circuitry, the subset of the first image from the first image, such as crop 351 as discussed above with reference to FIG. 3H.

In some examples, the electronic device identifies the subset (e.g., crop 352) of the at least the first image of the one or more images by identifying a predetermined region around the gaze direction (e.g., user gaze 360) of the user, such as shown above by FIG. 3J.

In some examples, the electronic device identifies the subset (e.g., crop 353) of the at least the first image (e.g., input 160a) of the one or more images by identifying a region around the gaze direction of the user, wherein dimensions of the region around the gaze direction is based on a distance of the user from one or more objects at a focal point of the gaze direction of the user, such as the crop 353 performed by the electronic device as shown in FIG. 3L.

In some examples, the operation (e.g., generating timer 162 as discussed above) includes causing a secondary electronic device (e.g., hand-held electronic device 160) in communication with the electronic device (e.g., electronic device 101) to output, via one or more output devices (e.g., display generation component(s) 214B shown in FIG. 2B) of the secondary electronic device, information related to one or more objects included in the subset of the first image, such as the infographic 165 as shown by FIG. 3L.

In some examples, the operation includes causing a secondary electronic device (e.g., hand-held device 160) in communication with the electronic device (e.g., electronic device 101) to initiate an application based on one or more objects (e.g., poster 340) included in the subset of the first image, such as initiating the display of website 167 at an application as shown in FIG. 3P.

In some examples, performing the operation includes scheduling a future event or notification corresponding to one or more objects (e.g., poster 340) included in the subset of the first image, such as the hand-held electronic device 160 displaying reminder 166 as shown in FIG. 3N.

In some examples, the input includes a language-command, such as the user voice command 374 as shown in FIG. 3M.

In some examples, the language command corresponds to a text input directed to a secondary electronic device (e.g., hand-held electronic device 160) in communication with the electronic device, such as text input 377 as shown and discussed above with reference to FIG. 3E.

In some examples, the language command (e.g., user voice command 374) corresponds to an audio input detected by an audio sensor, such as microphone(s) 213A and 213B shown in FIGS. 2A and 2B.

In some examples, the process of identifying the subset (e.g., crop 354) of the first image (e.g., three-dimensional environment 130) is based on a demonstrative pronoun in the audio input, such as the electronic device 101 detecting “this” in user voice command 373 as shown in FIG. 3K.

In some examples, the first image is selected based on an offset in time from which the demonstrative pronoun (e.g., user voice command 373 discussed above) is detected.

In some examples, identifying the subset of the at least the first image is based on an image segmentation model, the input, and the gaze direction, such as shown by inputs 160a through 160c in FIG. 3C.

In some examples, capturing the one or more images is in response to actuation of (e.g., hand press 380) a button or touch sensor, as illustrated by FIG. 3D.

In some examples, capturing or selecting the first image (e.g., 160a) is based on detecting a demonstrative pronoun in the audio input, such as “this” in the user voice command 371 as shown in FIG. 3G.

In some examples, the electronic device (e.g., hand-held electronic device 160) performs the operation in accordance with identifying a first subset (e.g., crop 351) of the at least first image, performing a first operation based on one or more first objects in the first subset of the at least first image and the input (e.g., user voice command 372), such as identifying pasta 313, carrot 312, and apple 311 as shown in FIGS. 3H and 3I. In some examples, the electronic device performs the operation in accordance with identifying a second subset (e.g., 352) of the at least first image, different from the first subset, performing a second operation, different than the first operation, based on one or more second objects, different than the one or more first objects, in the second subset of the at least first image and the input (e.g., user voice command 373), such as identifying carrot 312 as shown in FIG. 3J.

In some examples, the one or more images, the subset of the first image, and the input are provided to a model accepting one or more image inputs and one or more language inputs, such as inputs 160a through 160c shown in FIG. 3H.

In some examples, the model is stored at the electronic device, such as the electronic device 101 shown in FIG. 3H.

In some examples, the model is stored at a secondary electronic device in communication with the electronic device, such as the hand-held electronic device 160 as shown in FIG. 3H. In some examples, the electronic device transmits the input, the one or more images, and the subset of the first image to the secondary electronic device (e.g., hand-held electronic device 160). In some examples, the electronic device (e.g., electronic device 101) receives an output of the model from the secondary electronic device.

In some examples, the one or more criteria include a criterion that is satisfied when processing the input, the one or more images, and the subset of the first image provides a request corresponding to one or more objects within the subset of the first image, such as inputs 160a through 160c as shown in FIG. 3J.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
an electronic device in communication with one or more one or more input devices:
detecting, via the one or more input devices, an input;
detecting, via the one or more input devices, a gaze direction of a user;
capturing, via the one or more input devices, one or more images;
identifying, using the gaze direction and a portion of the input, a subset of at least a first image of the one or more images; and
in accordance with a determination that one or more criteria are satisfied, performing, via processing circuitry, an operation based on processing the input, the one or more images, and the subset of the first image.

2. The method of claim 1, wherein identifying the subset of the at least the first image of the one or more images comprises:
cropping, via the processing circuitry, the subset of the first image from the first image;
identifying a predetermined region around the gaze direction of the user; or
identifying a region around the gaze direction of the user, wherein dimensions of the region around the gaze direction is based on a distance of the user from one or more objects at a focal point of the gaze direction of the user.

3. The method of claim 1, wherein the operation includes causing a secondary electronic device in communication with the electronic device to:
output, via one or more output devices of the secondary electronic device, information related to one or more objects included in the subset of the first image; or
initiate an application based on the one or more objects included in the subset of the first image.

4. The method of claim 1, wherein identifying the subset of the at least the first image is based on an image segmentation model, the input, and the gaze direction.

5. The method of claim 1, wherein capturing or the first image is selected based on detecting a demonstrative pronoun in the input, wherein the input includes an audio input that includes a language command.

6. The method of claim 1, wherein performing the operation comprises:
in accordance with identifying a first subset of the at least first image, performing a first operation based on one or more first objects in the first subset of the at least first image and the input; and
in accordance with identifying a second subset of the at least first image, different from the first subset, performing a second operation, different than the first operation, based on one or more second objects, different than the one or more first objects, in the second subset of the at least first image and the input.

7. The method of claim 1, wherein:
the one or more images, the subset of the first image, and the input are provided to a model stored at a secondary electronic device accepting one or more image inputs and one or more language inputs; and
the method further comprises:
transmitting the input, the one or more images, and the subset of the first image to the secondary electronic device; and
receiving an output of the model from the secondary electronic device.

8. The method of claim 1, wherein the one or more criteria include a criterion that is satisfied when processing the input, the one or more images, and the subset of the first image provides a request corresponding to one or more objects within the subset of the first image.

9. An electronic device comprising:
one or more processors;
memory; and
one or more programs stored in the memory and configured to be executed by the one or more processors, the one or more programs including instructions for:
detecting, via one or more input devices, an input;
detecting, via the one or more input devices, a gaze direction of a user;
capturing, via the one or more input devices, one or more images;
identifying, using the gaze direction and a portion of the input, a subset of at least a first image of the one or more images; and
in accordance with a determination that one or more criteria are satisfied, performing, via processing circuitry, an operation based on processing the input, the one or more images, and the subset of the first image.

10. The electronic device of claim 9, wherein identifying the subset of the at least the first image of the one or more images comprises:
cropping, via the processing circuitry, the subset of the first image from the first image;
identifying a predetermined region around the gaze direction of the user; or
identifying a region around the gaze direction of the user, wherein dimensions of the region around the gaze direction is based on a distance of the user from one or more objects at a focal point of the gaze direction of the user.

11. The electronic device of claim 9, wherein the operation includes causing a secondary electronic device in communication with the electronic device to:
output, via one or more output devices of the secondary electronic device, information related to one or more objects included in the subset of the first image; or
initiate an application based on the one or more objects included in the subset of the first image.

12. The electronic device of claim 9, wherein identifying the subset of the at least the first image is based on an image segmentation model, the input, and the gaze direction.

13. The electronic device of claim 9, wherein capturing or the first image is selected based on detecting a demonstrative pronoun in the input, wherein the input includes an audio input that includes a language command.

14. The electronic device of claim 9, wherein performing the operation comprises:
in accordance with identifying a first subset of the at least first image, performing a first operation based on one or more first objects in the first subset of the at least first image and the input; and
in accordance with identifying a second subset of the at least first image, different from the first subset, performing a second operation, different than the first operation, based on one or more second objects, different than the one or more first objects, in the second subset of the at least first image and the input.

15. The electronic device of claim 9, wherein:
the one or more images, the subset of the first image, and the input are provided to a model stored at a secondary electronic device accepting one or more image inputs and one or more language inputs; and
the one or more programs further include instructions for:
transmitting the input, the one or more images, and the subset of the first image to the secondary electronic device; and
receiving an output of the model from the secondary electronic device.

16. The electronic device of claim 9, wherein the one or more criteria include a criterion that is satisfied when processing the input, the one or more images, and the subset of the first image provides a request corresponding to one or more objects within the subset of the first image.

17. A non-transitory computer readable storage medium storing one or more programs, the one or more programs comprising instructions, which when executed by one or more processors of an electronic device, cause the electronic device to:
detect, via one or more input devices, an input;
detect, via the one or more input devices, a gaze direction of a user;
capture, via the one or more input devices, one or more images;
identify, using the gaze direction and a portion of the input, a subset of at least a first image of the one or more images; and
in accordance with a determination that one or more criteria are satisfied, perform, via processing circuitry, an operation based on processing the input, the one or more images, and the subset of the first image.

18. The non-transitory computer readable storage medium of claim 17, wherein identifying the subset of the at least the first image of the one or more images comprises:
cropping, via the processing circuitry, the subset of the first image from the first image;
identifying a predetermined region around the gaze direction of the user; or
identifying a region around the gaze direction of the user, wherein dimensions of the region around the gaze direction is based on a distance of the user from one or more objects at a focal point of the gaze direction of the user.

19. The non-transitory computer readable storage medium of claim 17, wherein the operation includes causing a secondary electronic device in communication with the electronic device to:
output, via one or more output devices of the secondary electronic device, information related to one or more objects included in the subset of the first image; or
initiate an application based on the one or more objects included in the subset of the first image.

20. The non-transitory computer readable storage medium of claim 17, wherein identifying the subset of the at least the first image is based on an image segmentation model, the input, and the gaze direction.

21. The non-transitory computer readable storage medium of claim 17, wherein capturing or the first image is selected based on detecting a demonstrative pronoun in the input, wherein the input includes an audio input that includes a language command.

22. The non-transitory computer readable storage medium of claim 17, wherein performing the operation comprises:
in accordance with identifying a first subset of the at least first image, performing a first operation based on one or more first objects in the first subset of the at least first image and the input; and
in accordance with identifying a second subset of the at least first image, different from the first subset, performing a second operation, different than the first operation, based on one or more second objects, different than the one or more first objects, in the second subset of the at least first image and the input.

23. The non-transitory computer readable storage medium of claim 17, wherein:
the one or more images, the subset of the first image, and the input are provided to a model stored at a secondary electronic device accepting one or more image inputs and one or more language inputs; and
the instructions, when executed by the one or more processors, further cause the electronic device to:
transmit the input, the one or more images, and the subset of the first image to the secondary electronic device; and
receive an output of the model from the secondary electronic device.

24. The non-transitory computer readable storage medium of claim 17, wherein the one or more criteria include a criterion that is satisfied when processing the input, the one or more images, and the subset of the first image provides a request corresponding to one or more objects within the subset of the first image.
